(19) United States
(12) Patent Application Publication
(10) Pub. No.: US 2014/0369611 A1
(43) Pub. Date: Dec. 18, 2014

(54) IMAGE PROCESSING APPARATUS AND CONTROL METHOD THEREOF

(71) Applicant: CANON KABUSHIKI KAISHA, Tokyo (JP)

(72) Inventor: Yusuke Takeuchi, Kamakura-shi (JP)

(21) Appl. No.: 14/300,973

(22) Filed: Jun. 10, 2014

(30) Foreign Application Priority Data
Jun. 12, 2013 (JP) 2013-124172

(51) Int. Cl. G06T 11/60; G06K 9/00; G06T 3/40

(52) U.S. Cl. CPC G06T 11/60; G06T 3/40; G06K 9/00228; G06K 9/00369; G06T 2207/30201
USPC 382/224; 382/284

(57) ABSTRACT

An image processing apparatus comprises a first composition processing unit configured to compose a first image generated by a first image capturing unit and a second image generated by a second image capturing unit and generate a third image; and a detection unit configured to detect an area of the object from the third image.

### BACKGROUND OF THE INVENTION

1. Field of the Invention

The present invention relates to a technique of detecting an object from an image.

2. Description of the Related Art

Recent digital cameras include a camera (in-camera) for shooting a photographer himself/herself or an object on the photographer side in addition to a normal camera (out-camera) for shooting an object seen from the photographer. A digital camera incorporating such out-camera and in-camera can perform shooting by simultaneously releasing the shutters of the out-camera and in-camera upon pressing a shutter button and record an image on the in-camera side in association with an image on the out-camera side.

For example, Japanese Patent Laid-Open No. 2008-107942 describes a technique of alternately detecting the object of an out-camera image and that of an in-camera image, comparing the object of the out-camera image and that of the in-camera image, and determining spoofing when the objects match.

In Japanese Patent Laid-Open No. 2008-107942, one object detection unit alternately processes the out-camera image and the in-camera image, thereby implementing object detection for the out-camera image and the in-camera image. Hence, the frame rate of an image input to the object detection unit lowers as compared to a case where one image is processed by one object detection unit.

If an object detection unit is added to separately process the out-camera image and the in-camera image and suppress a decrease in the frame rate, the cost and power consumption increase.

### SUMMARY OF THE INVENTION

The present invention has been made in consideration of the aforementioned problems, and realizes an object detection technique capable of suppressing a decrease in a detection processing rate without increasing the cost and power consumption when performing object detection for an out-camera image and an in-camera image.

In order to solve the aforementioned problems, the present invention provides an image processing apparatus comprising: a first composition processing unit configured to compose a first image generated by a first image capturing unit and a second image generated by a second image capturing unit and generate a third image; and a detection unit configured to detect an area of the object from the third image.

In order to solve the aforementioned problems, the present invention provides a control method of an image processing apparatus which includes a composition unit configured to compose a plurality of images, and a detection unit configured to detect an area of the object from an image, the method comprising: a step of composing a first image generated by a first image capturing unit and a second image generated by a second image capturing unit and generating a third image, and a step of detecting an area of the object from the third image.

According to the present invention, it is possible to suppress a decrease in a detection processing rate without increasing the cost and power consumption when performing object detection for an out-camera image and an in-camera image.

Further features of the present invention will become apparent from the following description of exemplary embodiments (with reference to the attached drawings).

### BRIEF DESCRIPTION OF THE DRAWINGS

FIG. 1 is a block diagram showing an apparatus configuration according to an embodiment of the present invention;

FIG. 2A is a view showing an example of an out-camera image according to the first embodiment;

FIG. 2B is a view showing an example of an in-camera image according to the first embodiment;

FIG. 2C is a view showing an example of an image for face detection according to the first embodiment;

FIG. 2D is a view showing an example of an image for display according to the first embodiment;

FIG. 3 is a flowchart showing face detection processing according to the first embodiment;

FIG. 4A is a view showing an example of an out-camera image according to the second embodiment;

FIG. 4B is a view showing an example of an in-camera image according to the second embodiment;

FIG. 4C is a view showing an example of an image for face detection according to the second embodiment;

FIG. 4D is a view showing an example of an image for display according to the second embodiment;

FIG. 5 is a view for explaining free area determination processing according to the second embodiment; and

FIG. 6 is a flowchart showing face detection processing according to the second embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

An example will be described below in which an image processing apparatus according to the present invention is implemented by an image capturing apparatus such as a digital camera for shooting a moving image or still image. The present invention is also applicable to a portable electronic device such as a smartphone having a shooting function.

<Apparatus Configuration>

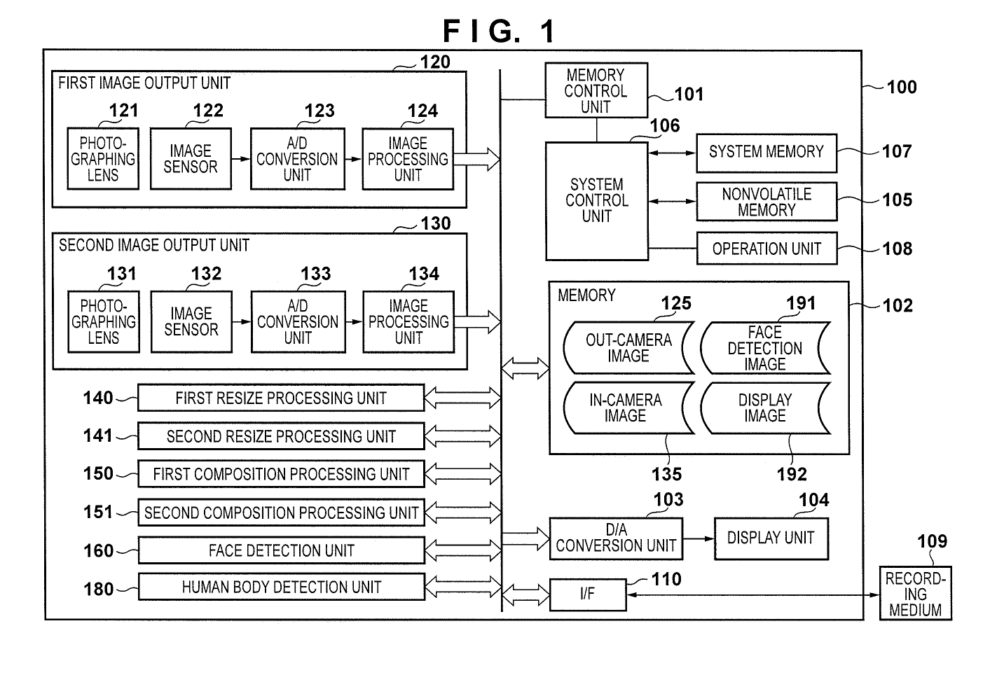

The configuration of a digital camera (to be referred to as a camera hereinafter) according to this embodiment will be described with reference to FIG. 1.

In a camera 100 shown in FIG. 1, a thin solid line indicates connection between blocks; a thick arrow, the direction of data input/output between a memory and a block via a memory control unit 101; a thin arrow, the direction of data input/output without intervening the memory control unit 101; and a thick line, a data bus.

The memory control unit 101 controls data input/output to/from a memory 102 that stores image data. The memory 102 also serves as a memory (video memory) for image display. Data input/output to/from the memory 102 is done via the memory control unit 101. The memory 102 has a sufficient storage capacity to store a predetermined number of still images or a moving image and audio of a predetermined time.

A D/A conversion unit 103 converts image display data stored in the memory 102 into an analog signal and supplies it to a display unit 104.

The display unit 104 is a display device such as an LCD panel, and displays a shooting screen and a focus detection area at the time of shooting in addition to an image according to the analog signal supplied from the D/A conversion unit 103, a GUI for operation assist, a camera status, and the like. The display unit 104 according to this embodiment has a resolution of 640 horizontal pixels×480 vertical pixels (to be referred to as 640×480 hereinafter).

A nonvolatile memory 105 is an electrically erasable/recordable memory and uses, for example, an EEPROM. The nonvolatile memory 105 stores constants, programs, and the like for the operation of a system control unit 106. The programs here indicate programs used to execute various flowcharts to be described later in the embodiment.

The system control unit 106 controls the whole camera 100. The system control unit 106 executes the programs recorded in the nonvolatile memory 105, thereby implementing the processes of the embodiment to be described later.

A system memory 107 is a RAM used to extract constants and variables for the operation of the system control unit 106, programs read out from the nonvolatile memory 105, and the like.

An operation unit 108 is appropriately assigned functions in each scene and acts as various function buttons when, for example, the user selects and operates various kinds of function icons displayed on the display unit 104. Examples of the function buttons are a shooting button, end button, back button, image scrolling button, jump button, narrowing-down button, and attribute change button. For example, a menu screen that enables various kinds of settings to be made is displayed on the display unit 104 by pressing a menu button. The user can make various kinds of settings intuitively using a menu screen displayed on the display unit 104, four-direction buttons and a set button.

A recording medium 109 is a hard disk or a memory card detachable from the camera 100, and is accessibly connected via an I/F (interface) 110.

A first image output unit 120 is an out-camera module that captures an object seen from a photographer. A second image output unit 130 is an in-camera module that captures the photographer.

The image output units 120 and 130 include photographing lenses 121 and 131, image sensors 122 and 132, A/D conversion units 123 and 133, and image processing units 124 and 134, respectively.

Each of the photographing lenses 121 and 131 is an image capturing optical system including a zoom lens, a focus lens, and a stop. Each of the image sensors 122 and 132 is formed from an image capturing element such as a CCD or CMOS sensor that converts an optical image of an object (photographer) into an electrical signal.

Each of the A/D conversion units 123 and 133 includes a CDS (Correlated Double Sampling) circuit that removes output noise of the image capturing element and a nonlinear amplification circuit that performs processing before A/D conversion, and converts an analog signal output from a corresponding one of the image sensors 122 and 132 into a digital signal.

Each of the image processing units 124 and 134 performs predetermined color conversion processing for data from a corresponding one of the A/D conversion units 123 and 133. Each of the image processing units 124 and 134 also performs predetermined arithmetic processing using captured image data. The system control unit 106 performs exposure control and distance measurement control based on the obtained arithmetic results.

An out-camera image 125 and an in-camera image 135, which have undergone various kinds of processing by the image processing units 124 and 134, are stored in the memory 102. The out-camera image and the in-camera image have a size of 640×480.

A first resize processing unit 140 and a second resize processing unit 141 perform resize processing such as predetermined pixel interpolation and reduction for an image input from the memory 102. The first resize processing unit 140 performs resize processing for the out-camera image 125 and outputs it to the memory 102. The second resize processing unit 141 performs resize processing for the in-camera image 135 and outputs it to the memory 102.

A first composition processing unit 150 and a second composition processing unit 151 compose the two images, that is, the out-camera image 125 and the in-camera image 135 input from the memory 102 into one image and output the composite image to the memory 102. The first composition processing unit 150 generates an image 191 for face detection (to be referred to as a face detection image hereinafter) to be output to a face detection unit 160 configured to detect an object face. The second composition processing unit 151 generates an image 192 to be displayed (to be referred to as a display image hereinafter) on the display unit 104 via the D/A conversion unit 103.

The face detection image 191 is output from the first composition processing unit 150 to the memory 102. The display image 192 is output from the second composition processing unit 151 to the memory 102.

The face detection unit 160 detects the number, positions, and sizes of faces of persons as objects included in the face detection image 191 input from the memory 102, and outputs the face detection result to the memory 102. The size of an image processable by the face detection unit 160 is 640×480.

A human body detection unit 180 detects the number, positions, and sizes of human bodies by applying a known human body detection technique using appropriate image processing such as moving element extraction and edge detection to the face detection image 191 input from the memory 102, and outputs the detection result to the memory 102. Note that details of human body detection processing are known, and a description thereof will be omitted.

<Explanation of Operation>

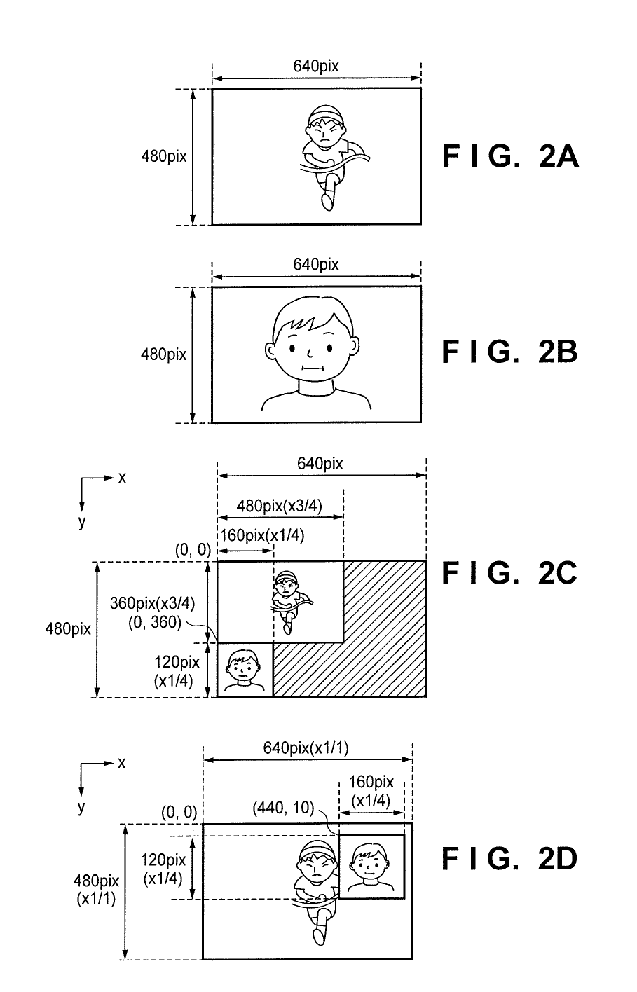

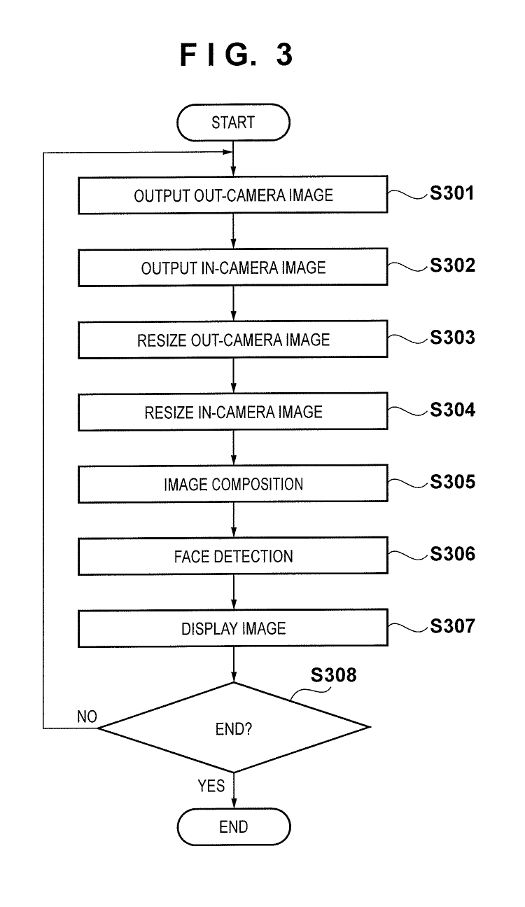

Face detection processing according to the first embodiment will be described next with reference to FIGS. 2 and 3.

An example will be explained below in which the first resize processing unit 140 and the second resize processing unit 141 perform resize processing of the out-camera image 125 and the in-camera image 135, respectively, and the first composition processing unit 150 generates a face detection image by composition of the images and outputs it to the face detection unit 160.

FIG. 2A shows an example of the out-camera image 125, and its size is 640×480. FIG. 2B shows an example of the in-camera image 135, and its size is 640×480. FIG. 2C shows an example of the face detection image 191, which is a composite image obtained by resizing the out-camera image 125 and the in-camera image 135 and adjacently laying out them so that the composite image falls within the range of 640×480 that is the size processable by the face detection unit 160. The out-camera image 125 is resized at a resizing rate of ¾ so as to have a size of 480 horizontal pixels×360 vertical pixels (to be referred to as 480×360 hereinafter), and laid out at a position (0, 0). The in-camera image 135 is resized at a resizing rate of ¼ so as to have a size of 160×120, and laid out at a position (0, 360).

FIG. 2D shows an example of the display image 192 displayed on the display unit 104, in which the in-camera image 135 is laid out so as to be superimposed on the out-camera image 125. The out-camera image 125 falls within the range of 640×480 that is the resolution of the display unit 104. Hence, the out-camera image 125 does not undergo resize processing by the second resize processing unit 141 and is laid out at a position (0, 0). The in-camera image 135 is resized at a resizing rate of ¼ so as to have a size of 160×120, and laid out at a position (440, 10).

Note that the resizing rate of the second resize processing unit 141 and the composition position by the second composition processing unit 151 are not limited to the values shown in FIG. 2C as long as the images are laid out within the size processable by the face detection unit 160. For example, when the out-camera image 125 is resized at a resizing rate of ¼, and the in-camera image 135 is resized at a resizing rate of ¾, the face detection accuracy of the in-camera image 135 can be improved as compared to the out-camera image 125.

Note that the layout of the display image 192 is not limited to that shown in FIG. 2D as long as it is an image different from the face detection image 191. For example, when the system control unit 106 controls to display the out-camera image 125 on the display unit 104, it is possible to prevent the object captured by the out-camera module from being hidden by the image captured by the in-camera module.

Face detection processing according to this embodiment will be described next with reference to FIG. 3.

Note that processing shown in FIG. 3 is implemented by causing the system control unit 106 to load a program stored in the nonvolatile memory 105 on the system memory 107 and execute it.

Referring to FIG. 3, in step S301, the system control unit 106 controls the first image output unit 120 to shoot the out-camera image 125 and output it to the memory 102.

In step S302, the system control unit 106 controls the second image output unit 130 to shoot the in-camera image 135 and output it to the memory 102.

In step S303, the system control unit 106 sets the resizing rate of the out-camera image 125 by the first resize processing unit 140 to ¾ shown in FIG. 2C. The first resize processing unit 140 performs resize processing of the out-camera image 125 stored in the memory 102, and outputs it to the memory 102.

In step S304, the system control unit 106 sets the resizing rate of the in-camera image 135 by the second resize processing unit 141 to ¼ shown in FIG. 2C. The second resize processing unit 141 performs resize processing of the in-camera image 135 stored in the memory 102, and outputs it to the memory 102.

In step S305, the first composition processing unit 150 composes the out-camera image 125 and the in-camera image 135, which are resized in steps S303 and S304, respectively, such that they are laid out adjacently, and outputs the composite image to the memory 102 as the face detection image 191. In the example of FIG. 2C, the first composition processing unit 150 lays out the out-camera image 125 at a position (0, 0) and the in-camera image 135 at a position (0, 360) and composes them, thereby generating the face detection image 191 as a composite image.

In step S306, the system control unit 106 performs face detection processing for the face detection image 191 input to the face detection unit 160.

In step S307, the second composition processing unit 151 composes the out-camera image 125 output from the first image output unit 120 in step S301 and the in-camera image 135 output from the second resize processing unit 141 instep S304. The second composition processing unit 151 outputs the composite image to the memory 102 as the display image 192. The display image 192 is composed in a layout different from that of the face detection image 191. The system control unit 106 displays the display image 192 output to the memory on the display unit 104. In the example of FIG. 2D, the second composition processing unit 151 lays out the out-camera image 125 at a position (0, 0) and the in-camera image 135 at a position (440, 10) and composes them.

In step S308, the system control unit 106 determines whether an instruction to end the processing is received from the user via the operation unit 108. If the instruction is received, the processing ends. If the instruction is not received, the process returns to step S301.

As described above, according to this embodiment, the system control unit 106 controls the first and second image output units 120, 130 to compose the out-camera image 125 and the in-camera image 135 after the images 125, 135 are resized and output the composite image to the face detection unit 160. The face detection unit 160 performs face detection processing for the composite image. This configuration makes it possible to perform face detection without increasing the cost and power consumption needed for the face detection processing and without lowering the frame rate of an input image as compared to a case where face detection is performed based on two or more images.

Note that although the system control unit 106 controls the face detection unit 160 to perform face detection processing to detect an object in step S306 of FIG. 3, a human body area may be detected by the human body detection unit 180. In this case, it is possible to perform human body detection without increasing the cost and power consumption needed for the human body detection processing and without lowering the frame rate of an input image as compared to a case where human body detection is performed based on two or more images.

### Second Embodiment

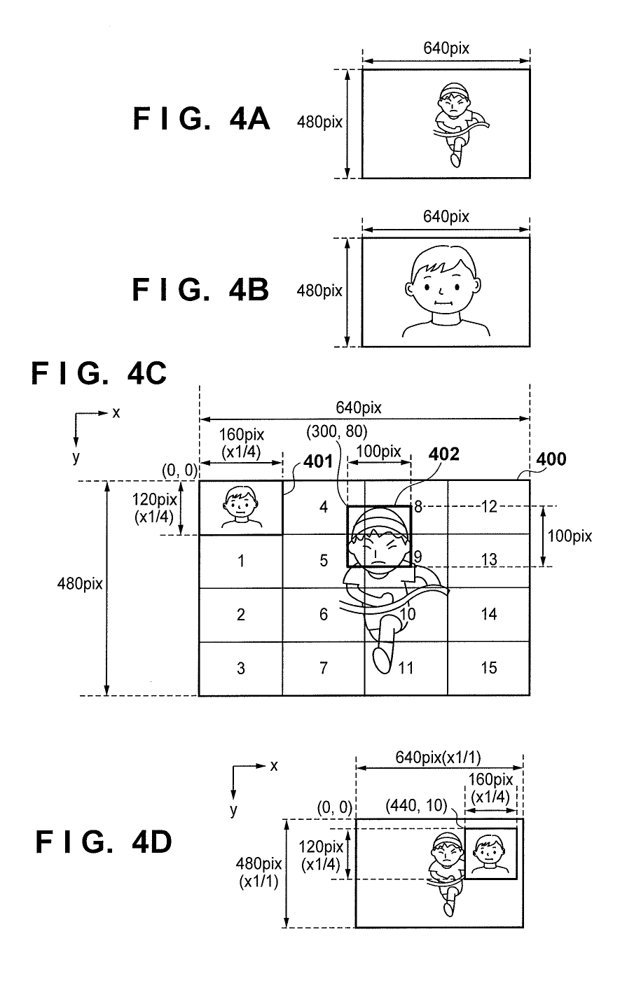

An example will be described next as the second embodiment with reference to FIGS. 4A to 6, in which an in-camera image 135 is laid out in an area (to be referred to as a free area hereinafter) where the image is not superimposed on persons included in an out-camera image 125, and composed.

FIG. 4A shows an example of the out-camera image 125 that is the same as in FIG. 2A, and its size is 640×480. FIG. 4B shows an example of the in-camera image 135 that is the same as in FIG. 2B, and its size is 640×480. FIG. 4C shows an example of a face detection image 191, in which the area of the out-camera image 125 is divided into a plurality of areas (16 areas in FIG. 4C), and the in-camera image 135 is resized so as to fall within a divided area and laid out. Referring to FIG. 4C, reference numeral 400 denotes the face detection image 191 of this embodiment, whose size is a size (640×480) inputtable to a face detection unit 160 and is equal to the size of the out-camera image 125. Reference numeral 401 denotes a divided area obtained by dividing the area of the out-camera image 125. The size of the divided area 401 is 160×120. The in-camera image 135 is resized at a resizing rate of ¼ so as to fall within the size of the divided area 401 and laid out at a position (0, 0). The divided areas 401 will be referred to as areas 0 to 15 hereinafter. Reference numeral 402 denotes an area of a person included in the out-camera image 125 detected from the face detection image 191, which has a position (300, 80) and a size of 100 horizontal pixels×100 vertical pixels (to be referred to as 100×100 hereinafter), and corresponds to areas 4, 5, 8, and 9. FIG. 4D shows an example of a display image 192 that is the same as in FIG. 2D.

Note that the size of the divided area 401 is not limited to the numerical value shown in FIG. 4C. For example, when the area of the out-camera image 125 is divided into a total of four areas 0 to 3, each of areas 0 to 3 has a size of 320×240. In this case, the resizing rate of the in-camera image 135 is ½, and this can improve the face detection accuracy of the in-camera image 135 as compared to the numerical value shown in FIG. 4C.

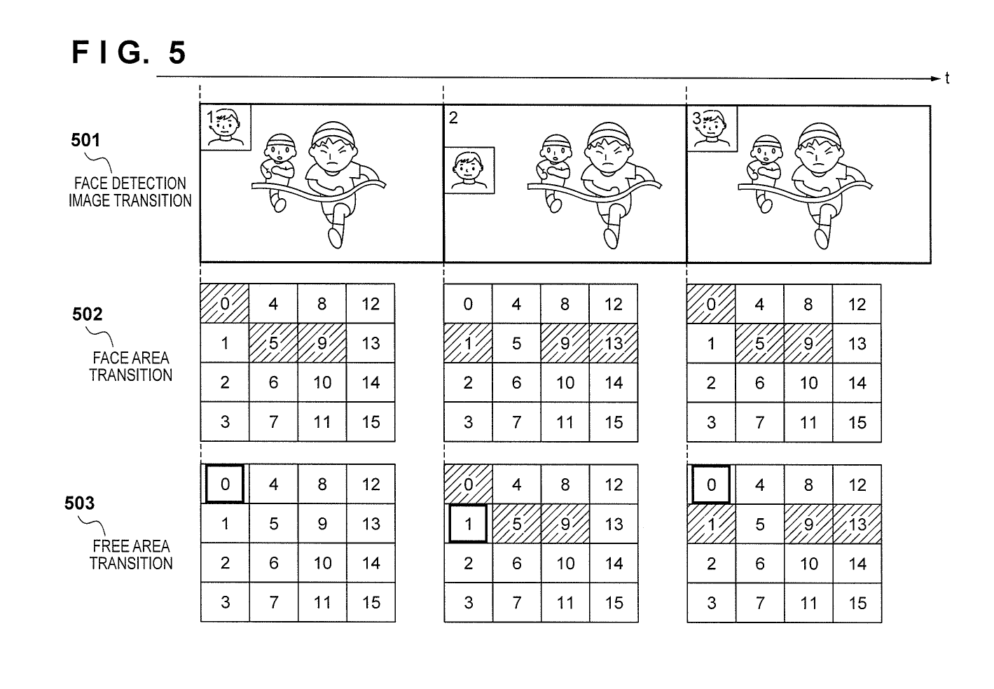

Processing of determining a free area of the out-camera image 125 in face detection processing according to this embodiment will be described here with reference to FIG. 5.

Referring to FIG. 5, reference numeral 501 indicates a transition of the face detection image 191. A number at the upper left corner is a frame number. The face detection images 191 indicated by 501 in FIG. 5 will be referred to as frames 1, 2, and 3 hereinafter.

Reference numeral 502 indicates a transition of the face areas of persons included in the face detection image 191. Hatched areas indicate the face areas of persons included in the face detection image 191.

A face area indicates an area on which an area detected by the face detection unit 160 is superimposed in the divided areas shown in FIG. 4C. The face areas of the persons included in frame 1 are areas 0, 5, and 9. The face areas of the persons included in frame 2 are areas 1, 9, and 13. The face areas of the persons included in frame 3 are areas 0, 5, and 9.

Reference numeral 503 indicates a transition of free areas in the out-camera image 125. Hatched areas indicate the face areas of persons included in the face detection image 191. An area indicated by a thick frame represents an area where the in-camera image 135 is composed. Free areas in frame 1 are areas 0 to 15, and the position where the in-camera image 135 is composed is area 0. Free areas in frame 2 are areas other than areas 0, 5, and 9, and the position where the in-camera image 135 is composed is area 1. Free areas in frame 3 are areas other than areas 1, 9, and 13, and the position where the in-camera image 135 is composed is area 0.

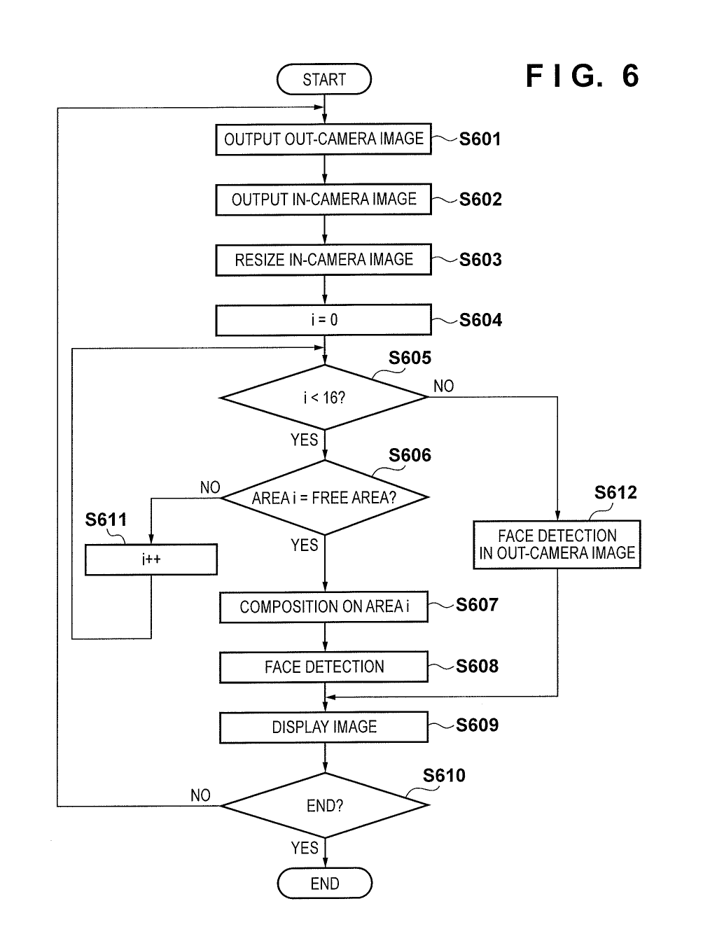

Face detection processing according to this embodiment will be described next with reference to FIG. 6.

Note that processing shown in FIG. 6 is implemented by causing a system control unit 106 to extract a program stored in a nonvolatile memory 105 on a system memory 107 and execute it. Steps S601 and S602 of FIG. 6 are the same as steps S301 and S302 of FIG. 3.

In step S603, the system control unit 106 sets the resizing rate of the in-camera image 135 by a second resize processing unit 141 to ¼ shown in FIG. 4C. The second resize processing unit 141 performs resize processing of the in-camera image 135 stored in a memory 102, and outputs it to the memory 102.

In step S604, the system control unit 106 substitutes 0 into a variable i. The variable i represents a counter when sequentially determining whether areas 0 to 15 shown in FIG. 4C are free areas. Values 0 to 15 correspond to areas 0 to 15, respectively. An area represented by the variable i will be referred to as an area i hereinafter.

In step S605, the system control unit 106 determines whether the variable i is smaller than 16. Upon determining that the variable i is smaller than 16, the system control unit 106 considers that determination for all of areas 0 to 15 shown in FIG. 4C has not ended yet, and the process advances to step S606.

In step S606, the system control unit 106 determines whether the area i is a free area. To decide the free area, the system control unit 106 decides, based on the face detection result of the immediately preceding frame, the position where the in-camera image 135 is to be superimposed. In frame 1 shown in FIG. 5, the face detection unit 160 has not output a face detection result. In this case, free areas in frame 1 shown in FIG. 5 are areas 0 to 15, and the in-camera image 135 is composed in area 0.

In frame 2 shown in FIG. 5, the system control unit 106 decides, based on the face detection result of frame 1, the position where the in-camera image 135 is to be superimposed. Face areas in frame 1 are areas 0, 5, and 9. In this case, free areas in frame 2 are areas other than areas 0, 5, and 9, and the in-camera image 135 is composed in area 1.

In frame 3 shown in FIG. 5, the system control unit 106 decides, based on the face detection result of frame 2, the position where the in-camera image 135 is to be superimposed. Face areas in frame 2 are areas 1, 9, and 13. In this case, free areas in frame 3 are areas other than areas 1, 9, and 13, and the in-camera image 135 is composed in area 0.

Upon determining in step S606 that the area i is not a free area, the process advances to step S611. The system control unit 106 increments the variable i and the process returns to step S605.

Upon determining in step S606 that the area i is a free area, the process advances to step S607. A first composition processing unit 150 superimposes and composes the in-camera image 135 resized in step S603 in the area i of the out-camera image 125 output in step S601. The first composition processing unit 150 outputs the composite image to the memory 102 as the face detection image 191. In the example of FIG. 4C, since the variable i is 0, the first composition processing unit 150 lays out the out-camera image 125 at a position (0, 0) and the in-camera image 135 at the position (0, 0) and composes them.

Steps S608 to S610 of FIG. 6 are the same as steps S306 to S308 of FIG. 3.

On the other hand, upon determining in step S605 that the variable i is not smaller than 16, the system control unit 106 considers that none of areas 0 to 15 shown in FIG. 4C have a free area, and the process advances to step S612.

In step S612, the system control unit 106 performs face detection processing for the out-camera image 125 input to the face detection unit 160, and the process advances to step S609.

As described above, according to this embodiment, the system control unit 106 superimposes and composes the resized in-camera image 135 in a free area that does not include faces in the out-camera image 125, and outputs the composite image to the face detection unit 160. This makes it possible to suppress the resizing rate when resizing the in-camera image 135 into a size processable by the face detection unit 160, in addition to the effect of the first embodiment. Hence, the face detection accuracy of the out-camera image 125 can be improved as compared to the first embodiment.

Note that although the system control unit 106 causes the face detection unit 160 to perform face detection processing in step S608 of FIG. 6, a human body area may be detected by a human body detection unit 180. In this case, the human body detection accuracy of the out-camera image 125 can be improved as compared to the first embodiment, in addition to the effect of the first embodiment.

In step S612 of FIG. 6, the system control unit 106 controls the face detection unit 160 to perform face detection processing for the out-camera image 125. However, the present invention is not limited to this. The system control unit 106 may decide a main object in the out-camera image 125 based on a predetermined evaluation value and superimpose the in-camera image 135 in a free area that does not include the main object. For example, the size of the face of an object in the out-camera image 125 detected in the preceding frame can be used as the predetermined evaluation value. In this case, an object having the largest face size is determined as the main object, and the in-camera image 135 is superimposed and composed in an area other than the main object. This makes it possible to perform face detection for the in-camera image 135 and the main object included in the out-camera image 125 even when no free area exists in the out-camera image 125.

The position of the face of an object in the out-camera image 125 detected in the preceding frame may be used as the predetermined evaluation value. In this case, an object whose face position in the out-camera image 125 is closest to the center is determined as the main object, and the in-camera image 135 is superimposed and composed in an area other than the main object. This makes it possible to perform face detection for the in-camera image 135 and the main object included in the out-camera image 125 even when no free area exists in the out-camera image 125.

Note that in this embodiment, an object is not limited to a person, and the same processing can be performed even for an animal other than a human.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-124172, filed Jun. 12, 2013 which is hereby incorporated by reference herein in its entirety.

What is claimed is:

1. An image processing apparatus comprising:
a first composition processing unit configured to compose a first image generated by a first image capturing unit and a second image generated by a image second capturing unit and generate a third image; and
a detection unit configured to detect an area of the object from the third image.

2. The apparatus according to claim 1, further comprising a second composition processing unit configured to compose the first image and the second image and generate a fourth image to be displayed on a display unit, which is different from the third image.

3. The apparatus according to claim 1, further comprising:
the first image capturing unit; and
the second image capturing unit.

4. The apparatus according to claim 1, wherein the first image capturing unit captures a first object and generates the first image, and the second image capturing unit captures a second object, which is different from the first object, and generates the second image.

5. The apparatus according to claim 2, further comprising a resize processing unit configured to resize the first image and the second image.

6. The apparatus according to claim 5, wherein
the resize processing unit includes a first resize processing unit configured to resize the first image into a size that enables detection processing by the detection unit, and a second resize processing unit configured to resize the second image into a size that enables detection processing by the detection unit,
the first composition processing unit composes the resized first image and the resized second image and generates the third image for detection by the detection unit, and
the second composition processing unit composes the resized first image and the resized second image and generates the fourth image to be displayed.

7. The apparatus according to claim 6, wherein a resizing rate of the first image by the first resize processing unit and the resizing rate of the second image by the second resize processing unit are different.

8. The apparatus according to claim 7, wherein the resizing rate of the first image is higher than the resizing rate of the second image.

9. The apparatus according to claim 7, wherein the resizing rate of the first image is lower than the resizing rate of the second image.

10. The apparatus according to claim 2, wherein
the first composition processing unit and the second composition processing unit determine whether there exists a free area usable to compose the second image with the first image,
when the free area exists, the second image is superimposed in the free area, and
when the free area does not exist, a main object included in the first image is decided based on a predetermined evaluation value, and the second image is superimposed in an area that does not include the main object.

11. The apparatus according to claim 10, wherein
the detection unit detects one of a face area and a human body area of a person, and
the predetermined evaluation value is a size of one of the face area and the human body area of the person detected by the detection unit.

12. The apparatus according to claim 10, wherein
the detection unit detects one of a face area and a human body area of a person, and
the predetermined evaluation value is a position of one of the face area and the human body area of the person detected by the detection unit.

13. A control method of an image processing apparatus which includes a composition unit configured to compose a plurality of images, and a detection unit configured to detect an area of the object from an image, the method comprising:
a step of composing a first image generated by a first capturing unit and a second image generated by a second capturing unit and generating a third image; and
a step of detecting an area of the object from the third image.

14. A non-transitory computer-readable storage medium storing a program for causing a computer to execute the control method according to claim 13.
